(19) United States
(12) Patent Application Publication
(10) Pub. No.: US 2014/0030414 A1
(43) Pub. Date: Jan. 30, 2014

(54) HERB-BUTTER COOKER

(71) Applicant: Terrianne Wehrli, Honolulu, HI (US)

(72) Inventor: Terrianne Wehrli, Honolulu, HI (US)

(21) Appl. No.: 13/562,225

(22) Filed: Jul. 30, 2012

(51) Int. Cl. A47J 9/00; A23C 15/02

(52) U.S. Cl. 426/581; 99/349; 99/341

(57) ABSTRACT

An appliance for making herb-seasoned butter is disclosed in the present invention. Said appliance is comprised of electric control means, herb-butter processing means and herb-butter collecting means. Said appliance does the melting, simmering, straining, pressing and collecting all in one machine.

### BACKGROUND OF THE INVENTION

### Field of the Invention

The present invention relates to an electric kitchen appliance. More particularly, the present invention relates to an electric herb-butter cooker.

Many cooking works now are done with electric kitchen appliances, such as electric rice cooker, electric pressure cookers, and many other examples. Electric kitchen appliances have made cooking works automatic, clean and easy.

Herb-butter is a popular food and is frequently made at home using multiple utensils and accessories. Thus it is desirable to have an electric kitchen appliance that makes the herb-butter cooking process, at least parts of it, to be automated, quicker and cleaner, which reduces the amount of manual labor exerted. It is also desirable to alleviate having to use or buy several separate utensils and items in order to make herb-butter at home.

### SUMMARY OF THE INVENTION

In an exemplary embodiment of the present invention, there is disclosed an electric kitchen appliance. More particularly, the present invention relates to an electric herb-butter cooker. Said herb-butter cooker is comprised of electric control means, herb-butter processing means and herb-butter collecting means. In one particular embodiment, it features a transparent lid with handle and a steam-release output. It also features a control panel and two compartments for herb-butter processing and collecting. One compartment holds water and accommodates a container with handles to hold the butter and herbs—this compartment serves as a “double boiler.” The other compartment with a fine mesh strainer holds the poured-in melted butter mixture. The strainer keeps any herb remnants behind as the strained liquid is dispensed into a collection container. A press is also used to ensure all the liquid is strained from the left-behind herbs.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a model of a particular embodiment of present invention.

FIG. 2A and FIG. 2B are illustrations of the components of electric control means of one particular embodiment of present invention.

FIG. 3A, FIG. 3B, FIG. 3C are illustrations of the components of a lid of one particular embodiment of present invention.

FIG. 4A, FIG. 4B, FIG. 4C and FIG. 4D are illustrations of the components of herb-butter processing means of a particular embodiment of present invention.

FIG. 5A, FIG. 5B, FIG. 5C, and FIG. 5D are illustrations of the components of herb-butter collecting means of a particular embodiment of the present invention.

FIG. 6A, FIG. 6B, and FIG. 6C are illustrations of the components of housing means of a particular embodiment of the present invention.

FIG. 7 is an illustration of the housing component of a particular embodiment of the present invention.

### DESCRIPTION OF THE PREFERRED EMBODIMENT

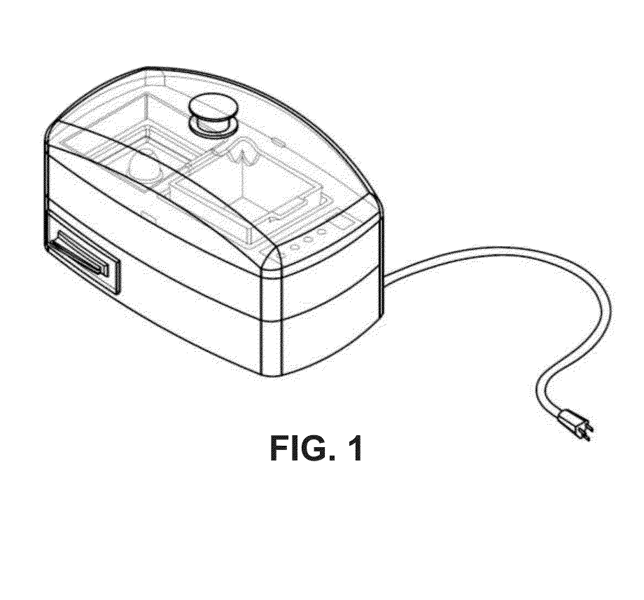

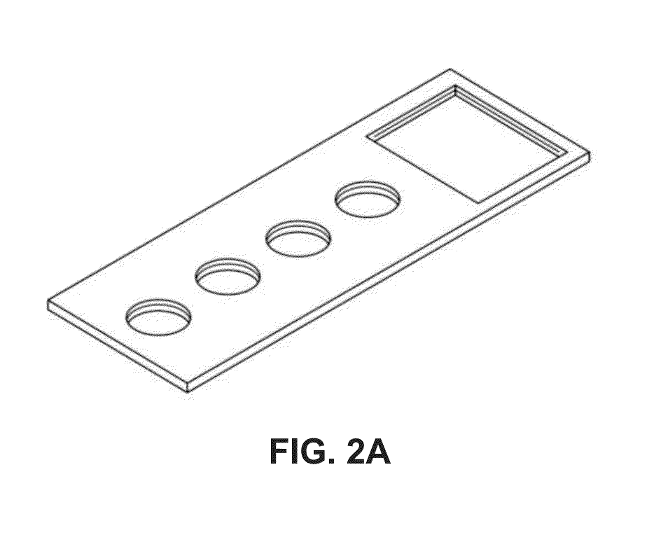

Referring to FIG. 1, there is disclosed an electric kitchen appliance. More particularly, the present invention relates to an electric herb-butter cooker. Said herb-butter cooker is comprised of electric control means, herb-butter processing means and herb-butter collecting means.

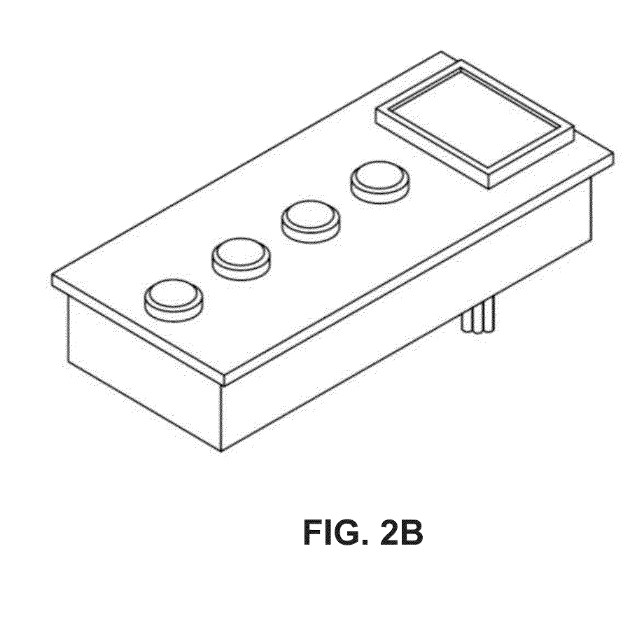

In one embodiment of the present invention, the electric control means of said herb-butter cooker are comprised of a control faceboard (FIG. 2A) and switches (FIG. 2B). The said control faceboard, with holes and openings that fit the size and shape of the switches, are placed on top of the said switches.

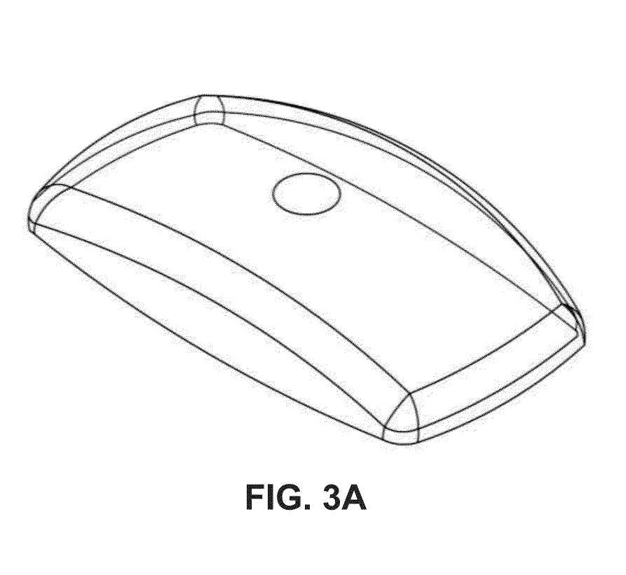

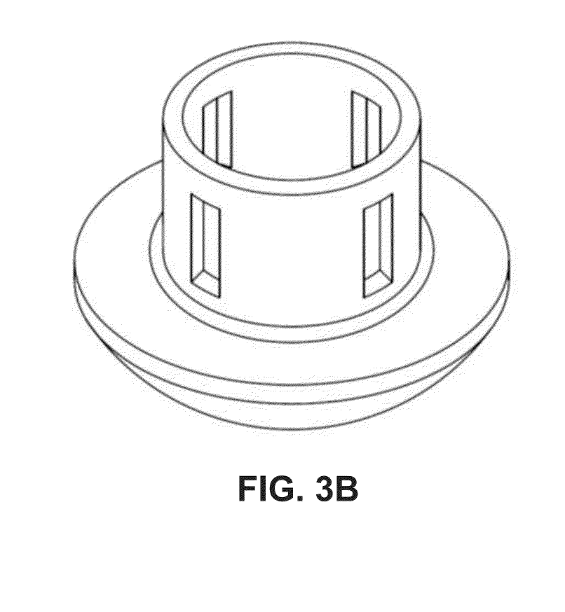

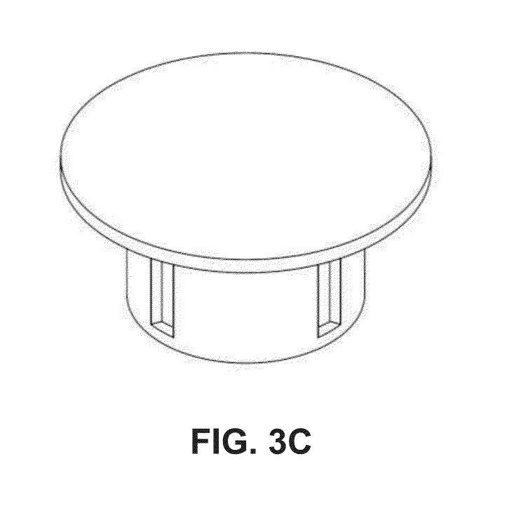

In another embodiment of the present invention, said herb-butter cooker is further comprised of a lid (FIG. 3). Said lid may be transparent with handles (FIG. 3A). Said lid also has an opening which holds a steam-release output (FIG. 3A). Said steam-release output is comprised of a vent (FIG. 3B) and a vent knob (FIG. 3C). Said vent has a hollow cylinder structure with openings at the wall of said cylinder structure, and a bottom structure at one end of the cylinder structure. The size of said cylinder fits the size of the opening in the lid, and the size of the bottom structure is bigger than the size of said opening in the lid. Said vent knob also has a cylinder structure with openings at the wall of said cylinder structure, and a top structure at one end of said cylinder structure. The inner diameter of the cylinder structure of vent knob fits the outer diameter of the cylinder structure of the vent so that the cylinder structure of the vent can be inserted into the cylinder structure of the vent knob. In one embodiment of the present invention, the lid, vent and vent knob are assembled by placing the vent through the opening in the lid so that the bottom structure of the vent is at the inner side of the lid and the cylinder structure protrudes the lid and is at the outer side of the lid; the vent knob is secured with the vent by placing the cylinder structure of vent inside the cylinder structure of vent knob. Said vent knob may rotate around the vent so that the openings at the two cylinder structures may be aligned together. At this position, the steam inside the herb-butter cooker may be released from these openings thus served as a steam-release output.

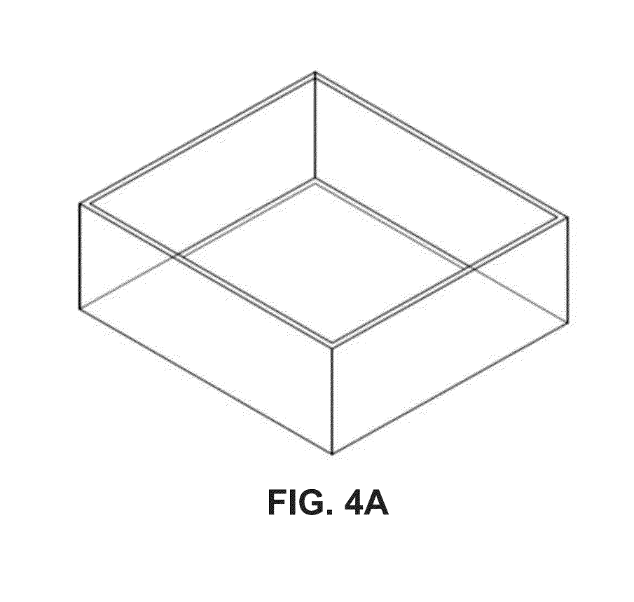

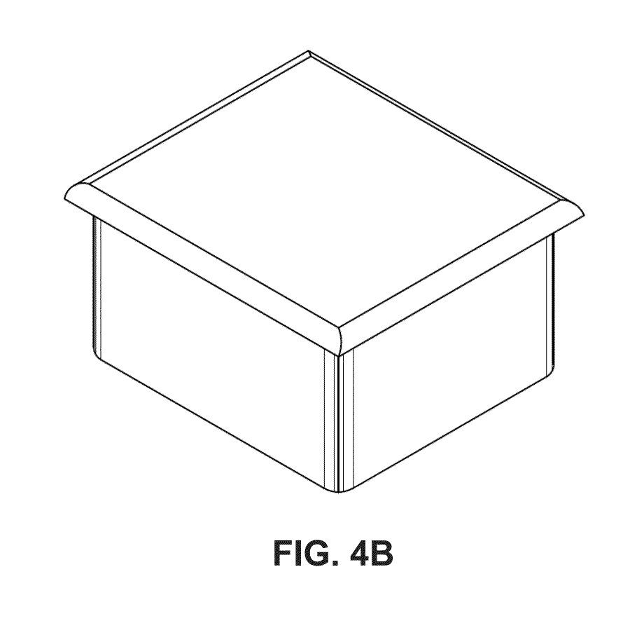

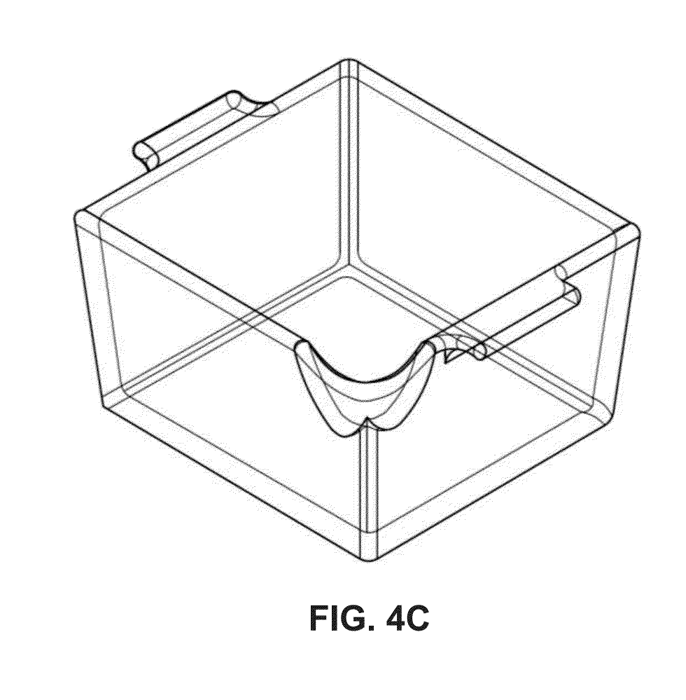

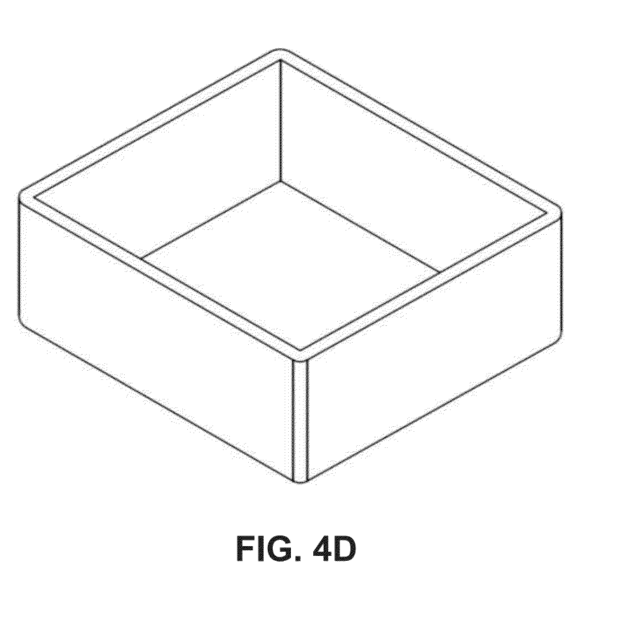

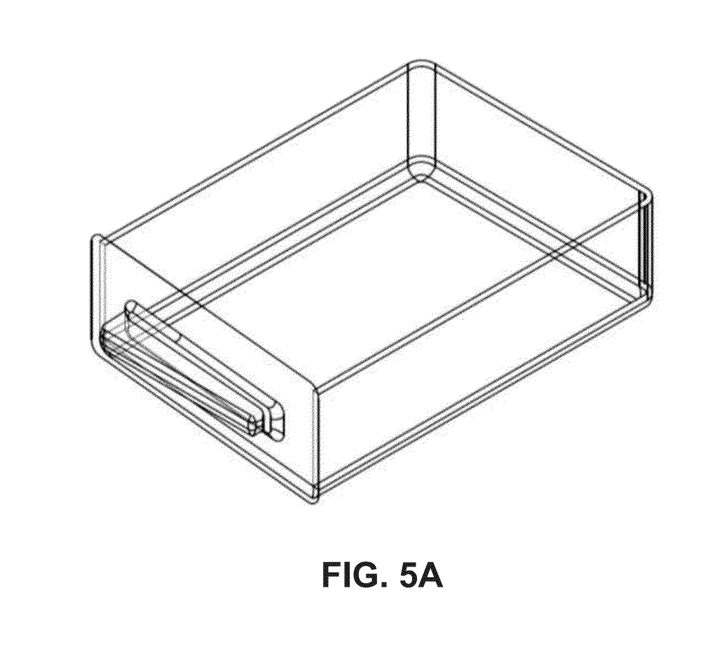

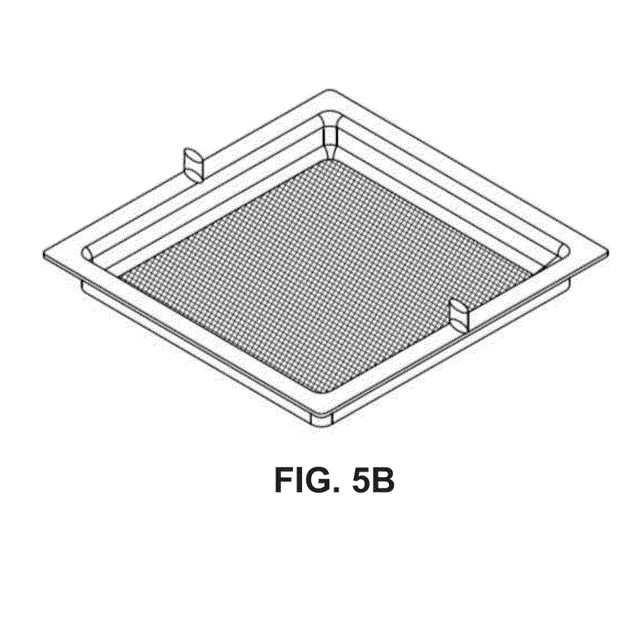

In another embodiment of the present invention, the herb-butter processing means of present invention are comprised of a water compartment (FIG. 4A), a built-in heat plate (FIG. 4B), and a container (FIG. 4C) which holds a mixture of butter and herb ingredients. In one embodiment of the present invention, said container may have a pour-spout corner structure (FIG. 4C) which is designed to guide the flow of the melted herb-butter liquid. User may put appropriate amount of water into the water compartment and the built-in heat plate can heat up the water. The said container is held in the water compartment thus such water compartment may serve as a “double boiler.” Also in another embodiment of present invention, the herb-butter processing means also include a heat shield (FIG. 4D) which is placed at the outer side of the water compartment to insulate the heat.

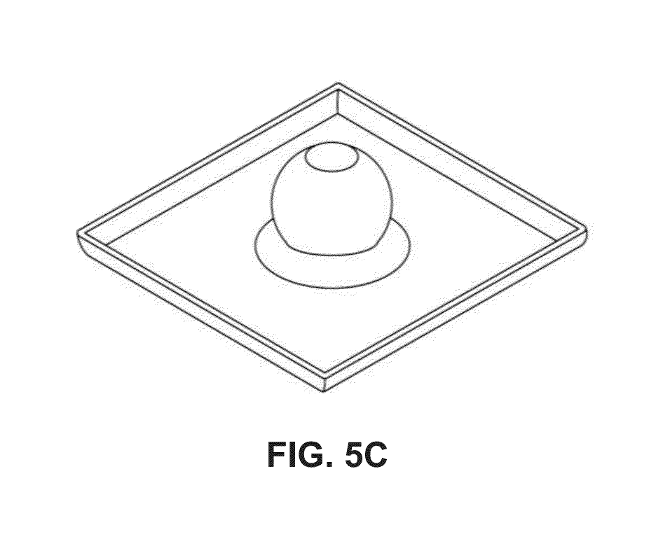

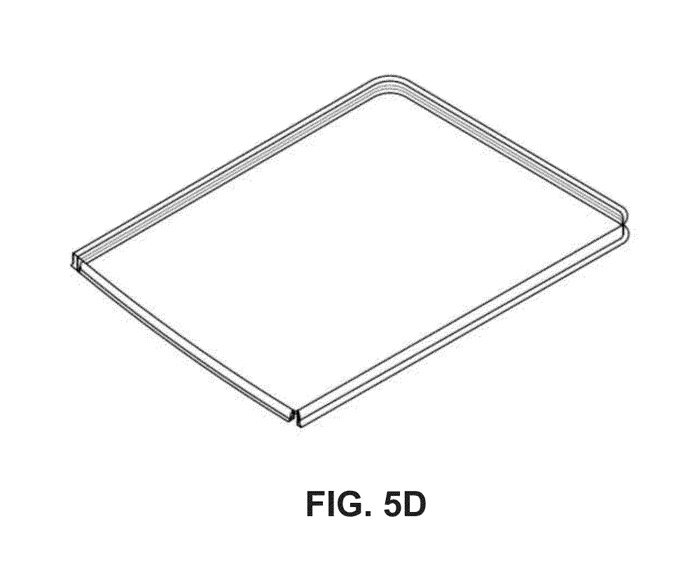

In another embodiment of the present invention, the herb-butter collecting means are comprised of a collection container (FIG. 5A), a mesh strainer (FIG. 5B) and a press (FIG. 5C). Said collection container may be removed from the herb-butter cooker and sealed with a lid (FIG. 5D). Said mesh strainer has a fine-mesh at the bottom and four upright walls with flat edges for each upright wall. The size of the mesh strainer matches the collection container so that the mesh strainer may be placed on the collection container. Said press has a knob and a size smaller than fine-mesh bottom of the mesh strainer. Said press is used to dispense all the liquid into collection container when the melted herb-butter mixture is poured into the mesh-strainer sitting on top of the collection container.

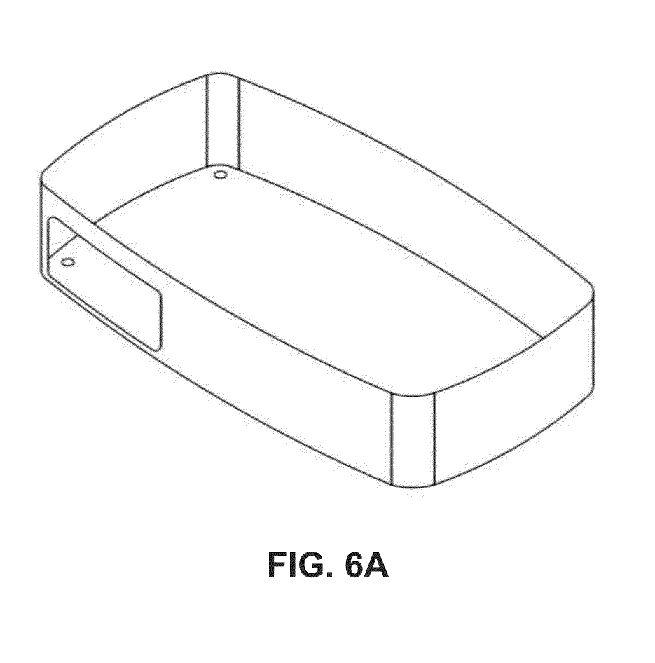

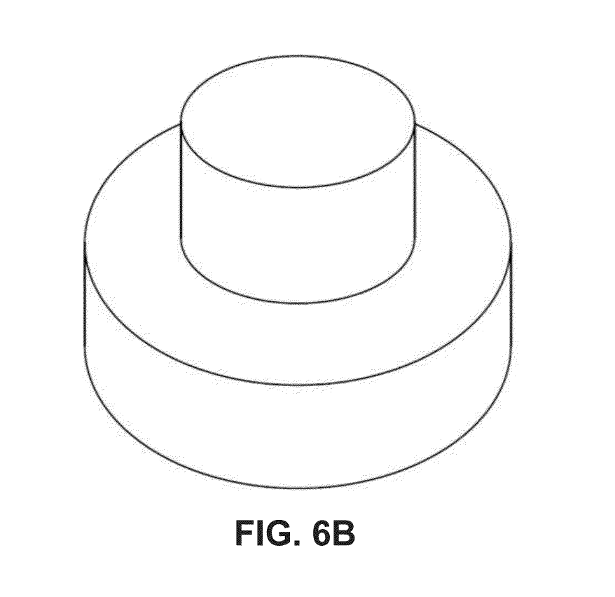

Yet in another embodiment of the present invention, the herb-butter cooker further includes a housing means (FIG. 6A) which holds the herb-butter processing means and herb-butter collecting means. Said housing means include a bottom housing component (FIG. 6A) with an opening at one side of longitude wall of said bottom housing component. Said opening has a size that fits the collection container (FIG. 5A) so that said collection container may be assembled into or removed from the herb-butter cooker. In one embodiment of the present invention, said bottom housing also has holes to hold foot cap (FIG. 6B) to provide a stable support to the herb-butter cooker. Said housing means also include a top housing component (FIG. 6C). Said top housing component has openings to hold electric control means, herb-butter processing means and herb-butter collecting means.

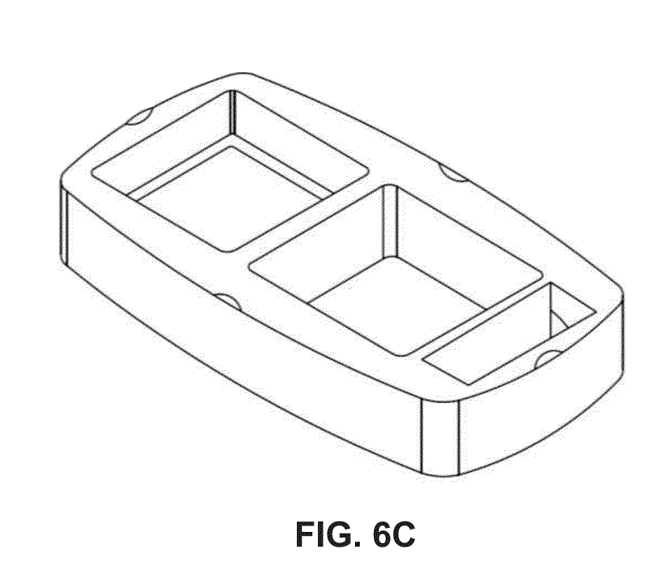

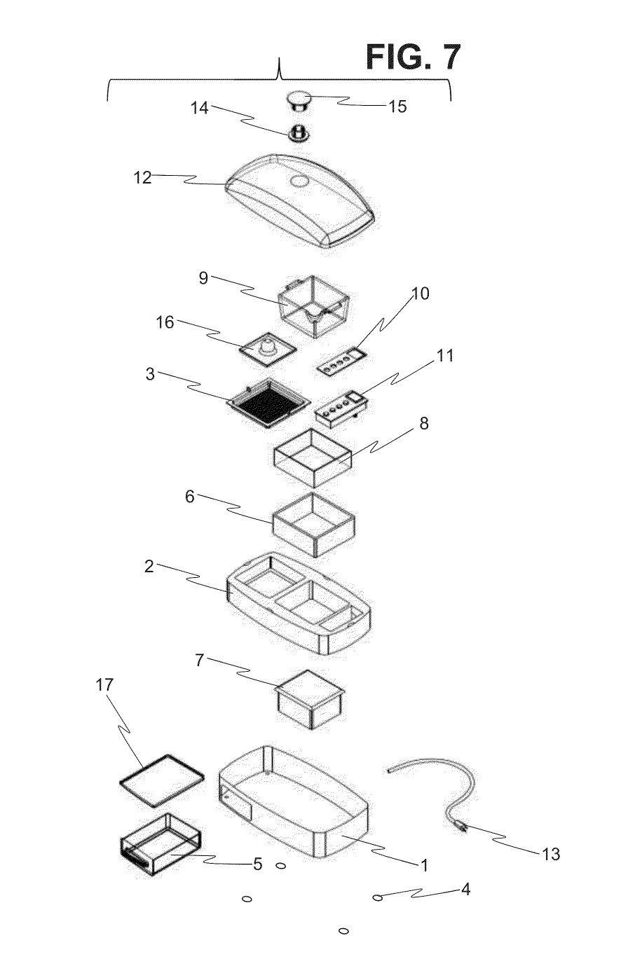

Yet in another embodiment of the present invention, as shown in FIG. 7, said herb-butter cooker is comprised of a bottom housing component, a top housing component, a mesh strainer, four foot caps, a herb-butter collection container, a heat shield, a built-in hot plate, a water compartment, a Pyrex-like bowl with a pour-spout corner, a control faceboard, electric control switches, a transparent lid with a round opening at the center, a power cord, a vent, a vent knob, and press and a collection container lid. The above components listed in this paragraph are assembled according to above described embodiments and are able to be disassemble and removed from the herb-butter cooker.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. An appliance of herb-butter cooker comprising:
a. electric control means,
b. herb-butter processing means, and
c. herb-butter collecting means.

2. An appliance of herb-butter cooker of claim 1, wherein further comprising of a lid, and a power cord.

3. An appliance of herb-butter cooker of claim 2, wherein said lid is transparent and with a handle and steam-release output.

4. An appliance of herb-butter cooker of claim 2, wherein the electric control means comprising a control face board and switches.

5. An appliance of herb-butter cooker of claim 2, wherein said herb-butter processing means comprising a water compartment, a heating element built-in and underneath the said water compartment, a heat shield, and a container with dual handles and pour-spout corner; said container rests on top of water compartment.

6. An appliance of herb-butter cooker of claim 2, wherein said herb-butter collecting means comprising a collection container, a collection container lid, a mesh strainer and a press; said mesh strainer holds the poured-in melted herb-butter mixture and keeps any herb remnants behind as the strained liquid is dispensed into said collection container; said press is used to ensure all the liquid is strained from the left-behind herbs.

7. An appliance of herb-butter cooker comprising:
a. a lid, wherein said lid is transparent and with handle and a steam-release output, said output is comprised of a vent and a vent knob;
b. electric control means, comprising:
i. a control face board,
ii. and switches;
c. herb-butter processing means, comprising:
i. a water compartment,
ii. a heating element built-in and underneath the said water compartment,
iii. a heat shield,
iv. and a container with dual handles and pour-spout corner, said container rests on top of water compartment;
d. herb-butter collecting means, comprising:
i. a collection container,
ii. a collection container lid,
iii. a mesh strainer,
iv. and a press;
said mesh strainer holds the poured-in melted herb-butter mixture and keeps any herb remnants behind as the strained liquid is dispensed into said collection container; said press is used to ensure all the liquid is strained from the left-behind herbs; and
e. a power cord.

8. An appliance of herb-butter cooker of claim 7, wherein the components of said herb-butter processing means and herb-butter collecting means are disassemble and removable.

9. A method of making herb-butter, comprising:
a. plug in an appliance of herb-butter cooker, comprising:
b. remove the lid;
c. add the appropriate amount of water into water compartment;
d. activate the heating element using electric control means then put the lid back on and heat up the water;
e. once optimum water temperature is reached, an alarm/alert activates, then add butter into said container with dual handles and pour-spout corner;
f. place said container into the water compartment;
g. melt butter;
h. add desired ground herb to the butter;
i. set the temperature and time;
j. stir occasionally;
k. pour melted mixture out into the mesh strainer which sits on top of the collection container, liquid is dispensed into the collection container, and remaining herb bits are left behind in mesh strainer, use the press tool to ensure all the liquid mixture is released;
l. seal the collection container with the lid and place the container in the refrigerator to sit for appropriate time.
